(19) United States
(12) Patent Application Publication
(10) Pub. No.: US 2026/0267205 A1
(43) Pub. Date: Sep. 10, 2026

(54) LENS APPARATUS AND IMAGING SYSTEM

(71) Applicant: CANON KABUSHIKI KAISHA, Tokyo (JP)

(72) Inventor: KATSUHIRO INOUE, Tochigi (JP)

(21) Appl. No.: 19/552,354

(22) Filed: Feb. 27, 2026

(30) Foreign Application Priority Data
Mar. 4, 2025 (JP) 2025-033423

(51) Int. Cl. G03B 17/12; G03B 5/00; G03B 13/34

(52) U.S. Cl. CPC G03B 17/12; G03B 5/00; G03B 13/34; G03B 2205/0046; G03B 2205/0069

(57) ABSTRACT

An imaging apparatus comprising: a holding portion configured to hold a lens; a connecting portion connected to the imaging apparatus; and a guide portion configured to guide a movement of the holding portion in an optical axis direction, wherein the connecting portion includes an abutting surface abutting on the imaging apparatus in the optical axis direction and a first fixing portion to which the guide portion is fixed, and wherein the first fixing portion is arranged at a position closer to an imaging surface than the abutting surface.

### BACKGROUND

### Field of the Technology

The present disclosure relates to a lens apparatus and an imaging system.

### Description of the Related Art

Japanese Patent Laid-Open No. 2013-011802 discloses a lens apparatus comprising a configuration in which end portions of a pair of guide shafts on an imaging plane side are held by a lens-side mount portion and end portions of the pair of guide shafts on an object side are held by a fixed barrel.

### SUMMARY

According to an embodiment of the present disclosure, there is provided a lens apparatus comprising: a holding portion configured to hold a lens, a connecting portion connected to the imaging apparatus, and a guide portion configured to guide a movement of the holding portion in an optical axis direction, wherein the connecting portion includes an abutting surface abutting on the imaging apparatus in the optical axis direction and a first fixing portion to which the guide portion is fixed, and wherein the first fixing portion is arranged at a position closer to an imaging surface than the abutting surface.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic cross-sectional view of a lens apparatus (100) according to example 1.

FIG. 2 is a schematic cross-sectional view of the lens apparatus (100) according to example 1 in a state where the exterior member (111) is incorporated.

FIG. 3 is a schematic cross-sectional view of the lens apparatus (100) according to example 2 in a state in which the exterior member (111) is incorporated.

FIG. 4 is a schematic diagram illustrating a configuration example of the imaging system.

### DESCRIPTION OF THE EMBODIMENTS

### Example 1

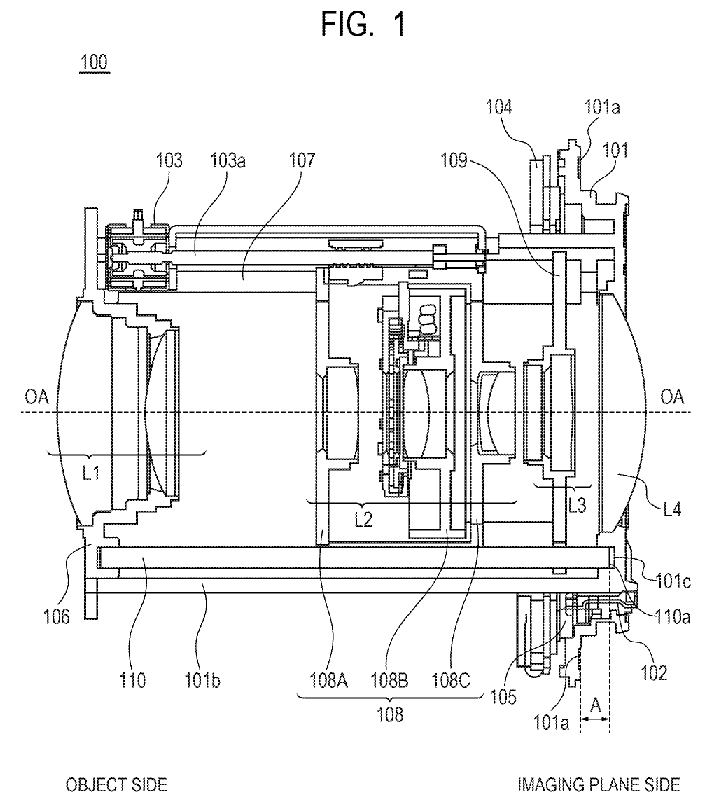

Preferred embodiments of the present disclosure will now be described in detail in accordance with the accompanying drawings. FIG. 1 is a schematic cross-sectional view of a lens apparatus (lens barrel) 100 according to example 1 of the present disclosure. Hereinafter, an aspect according to an example 1 of the present disclosure will be described with reference to FIG. 1.

Conventionally, in a lens apparatus of an optical apparatus such as a digital camera, there is a lens apparatus in which a focus unit and a zoom unit are guided in an optical axis direction by a guide bar. Such a lens apparatus includes an optical adjustment unit that tilts and decenters a part of an optical system of any one of a focus unit, a zoom unit, and a fixed lens unit in order to maximize optical performance.

First, the configuration disclosed in Japanese Patent Laid-Open No. 2013-011802 is a configuration in which the guide shaft is held by the lens-side mount portion but is not a configuration in which a plurality of members is held. Therefore, in the configuration disclosed in Japanese Patent Laid-Open No. 2013-011802, there is room for further reduction in size and weight.

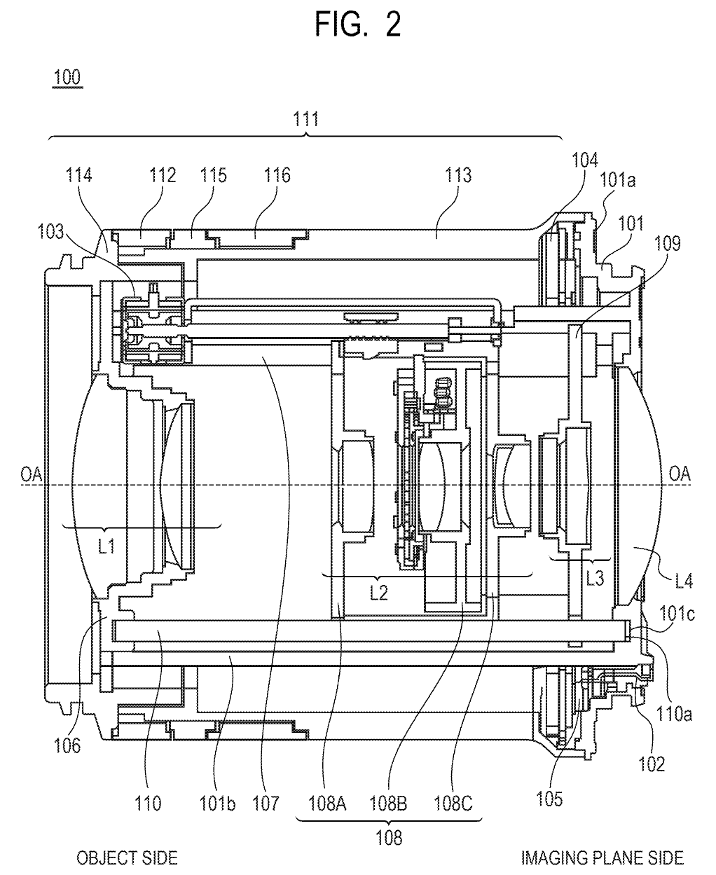

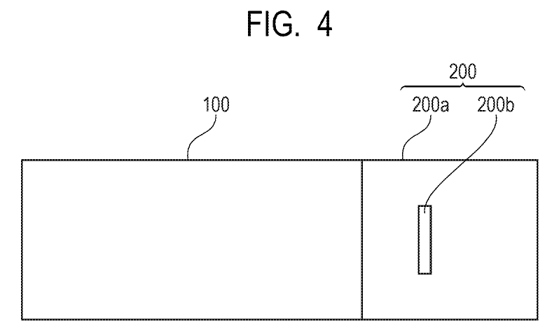

A lens apparatus 100 according to the example 1 of the present disclosure includes an imaging apparatus 200 includes a coupling member 101 as a mount (lens mount, mount unit) coupled to the imaging apparatus 200 (see FIG. 4), and a plurality of lens holding frames (to be described later) which hold lenses. Furthermore, focusing operation (focusing) or zooming operation (zooming) is performed by moving at least one of the multiple lens holder frames back and forth along the optical axis OA. The lens apparatus 100 includes a driving unit 103 (driving member) which moves at least one lens holding frame of the plurality of lens holding frames forward and backward along the optical axis OA. The lens apparatus 100 also includes a control board 104 which generates a driving signal to the driving unit 103, an exterior member 111 (see FIG. 2), and a signal transmission member 105 which transmits a control signal between the driving unit 103 or the exterior member 111 and the control board 104.

A communication member 102 comprising a lens-side electronic contact that abuts with an electronic contact on a camera body 200a side and transmits a lens-side communication control signal to the imaging apparatus 200 is fixed to a coupling member 101 that is detachable from the camera body 200a included in the imaging apparatus 200. The communication member 102 and the control board 104 for generating a drive signal to the driving unit 103 are connected by a flexible printed board which is the signal transmission member 105 for transmitting the control signal. Here, the flexible printed board is adopted as the signal transmission member 105, but a cable such as a lead wire of which both ends are fixed to the communication member 102 and the control board 104 by soldering may be adopted. The signal transmission member 105 is fixed to the coupling member 101. And a light amount regulating member (back cover) (not shown) for regulating the amount of light incident on the imaging apparatus 200 is fixed to the coupling member 101.

The control board 104 is incorporated into the coupling member 101 from the object side and includes an annular shape. In addition, the control board 104 may have a substantially C shape in which a part of an annular shape is cut and may have an opening around the optical axis OA, and a shape of an outer diameter portion may be a substantially polygonal shape. Further, the control board 104 may be a rigid flexible board which is wound around the optical axis OA.

The coupling member 101 includes an extending portion 101b extending in the optical axis direction, and the extending portion 101b is coupled (fixed) to a first lens holding frame 106 (holding member) that holds the first lens unit L1 on the object side of the extending portion 101b. Further, the lens apparatus 100 includes a first linear guide member 107 whose both ends are held by the first lens holding frame 106 and the coupling member 101. That is, the first lens holding frame 106 and the first linear guide member 107 are fixed to the coupling member 101.

Further, the lens apparatus 100 includes a second lens unit holding frame 108 (holding member) to which lens holding frames 108A, 108B and 108C are connected, that hold each of the plurality of lenses constituting the second lens unit L2. It includes a third lens holding frame 109 (holding member) that holds the third lens unit L3. One of the second lens unit L2 or the third lens unit L3 is a variable magnification lens unit that performs magnification change operations, and the other is a focus unit that performs a focusing operation. That is, at least one of the second lens unit holding frame 108 and the third lens holding frame 109 is moved forward and backward along the optical axis OA by the driving unit 103, so that the focusing operation or the zooming operation can be performed.

In addition, the optical system may have a multi-group configuration. FIG. 1 of the present example illustrates that a fourth lens unit L4 (a lens positioned on the imaging plane side) serving as a fixed unit is fixed to the coupling member 101. The fourth lens unit L4 is a lens located closest to the imaging surface among the lenses included in the lens apparatus 100 and is fixed to the coupling member 101. Depending on the optical type, a lens may not be fixed to the coupling member 101, a plurality of lenses may be fixed, or a lens holding frame may be fixed.

The second lens unit holding frame 108 and the third lens holding frame 109, which advance and retract along the optical axis OA, are linearly guided by the first linear guide member 107 so as to advance and retract along the optical axis OA. In addition, a second linear guide member 110 for regulating the movement of the second lens unit holding frame 108 and the third lens holding frame 109 in the rotational direction around the first linear guide member 107 is provided. Both ends of the second linear guide member 110 are also held by the first lens holding frame 106 and the coupling member 101.

An end portion 110a of the second linear guide member 110 on the imaging plane side is fixed by being fitted to a mounting portion (first fixing portion, fitting portion, concave portion) 101c formed in the coupling member 101. The mounting portion 101c is closer to the imaging plane side than an abutting surface 101a orthogonal to the optical axis OA on which the coupling member 101 is in contact with the imaging apparatus 200. And the end portion 110a is located a distance A closer to the imaging plane side than the abutting surface 101a with the camera body 200a. Similarly, an end portion (not shown) of the first linear guide member 107 on the imaging plane side is fitted to the coupling member 101 and is closer to the imaging plane side than the abutting surface 101a with the camera body 200a. Accordingly, the second lens unit holding frame 108 and the third lens holding frame 109 suspended by the first linear guide member 107 can have a fitting length in the optical axis direction with the first linear guide member 107 as long as possible within a movable range along the optical axis OA. This configuration prevents the lens retaining frames from tipping over.

At least one driving unit 103 for moving the second lens unit holding frame 108 and the third lens holding frame 109 forward and backward along the optical axis OA is fixed to the extending portion 101b of the coupling member 101 which extends toward the object side. The driving unit 103 is formed of, for example, a stepping motor, and is connected to the control board 104 by a flexible printed board as the signal transmission member 105. When a shaft 103a of the driving unit 103 rotates, the second lens unit holding frame 108 and the third lens holding frame 109, which are movable groups, are moved forward and backward along the optical axis OA.

Depending on the position in the optical axis direction of the control board 104 arranged on a plane orthogonal to the optical axis OA, various flexible printed circuit boards are connected to the control board 104 on the object side or the imaging plane side of the control board 104. Similarly, when the control board 104 is a rigid flexible board, various flexible printed boards are connected to the control board 104 from the object side or the imaging plane side depending on the position in the optical axis direction.

As described above, in the lens apparatus 100 according to the present exemplary example, the first lens holding frame 106 closest to the object side is fixed to the coupling member 101 closest to the imaging plane side of the lens apparatus 100. The second lens unit holding frame 108 and the third lens holding frame 109, which are movable units, are guided by the first linear guide member 107 and the second linear guide member 110. The control board 104 is incorporated from the object side of the coupling member 101 and fixed to the coupling member 101 and transmits a control signal to the driving unit 103 for driving the second lens unit holding frame 108 and the third lens holding frame 109.

In the lens apparatus 100, the first linear guide member 107 which holds the entire optical system and linearly guides the movable group, or the end portion 110a on the imaging plane side of the first linear guide member 107 and the second linear guide member 110 is arranged on the imaging plane side as much as possible. Accordingly, the lens apparatus 100 also includes a configuration in which the number of components is suppressed. In addition, since it is possible to access each lens unit from the radial direction in a state where the exterior member 111 is not attached, optical adjustment in the entire optical system is also simple. According to the present disclosure, it is possible to provide the lens apparatus 100 comprising a simple configuration when the optical adjustment of the optical system is performed in a state where the mount (the coupling member 101) is attached.

FIG. 2 is a schematic cross-sectional view of the lens apparatus 100 according to example 1 in a state in which the exterior member 111 is incorporated in the form of FIG. 1. The exterior member 111 is formed by fastening the components that make up the lens apparatus 100 to the coupling member 101 and finally assembling them from the object side of the coupling member 101 and fastening them to the coupling member 101. The control board 104 is arranged (fixed) on the inner side of the exterior member 111 and on the extending portion 101b of the coupling member 101.

The exterior member 111 includes a focus operating ring 112, an exterior ring 113, a filter frame 114, an intermediate barrel 115, and a zoom operating ring 116. The focus operating ring 112 having ring-shape, which is rotatable around the optical axis OA, is radially fitted into the exterior ring 113. And the position of the focus operating ring 112 in the optical axis direction is regulated by the filter frame 114 fixed to the exterior ring 113 with screws (not shown), and the intermediate barrel 115, which is also fixed to the exterior ring 113 with screws (not shown). The amount and direction of the rotation direction of the focus operating ring 112 are detected by a black and white reflective scale (not shown) held on an inner diameter of the focus operating ring 112, and a photodetector (not shown) arranged opposite the reflective scale. The photodetector is an electrical component mounted on a flexible printed circuit board (hereinafter, focus rotation detection flexible board, not shown), and the focus rotation detection flexible board is fixed to the exterior ring 113. The focus rotation detection flexible board is connected to a connector on the control board 104 but may be connected to the control board 104 via the signal transmission member 105 that transmits a control signal. The focus unit moves forward and backward along the optical axis OA according to the amount and direction of the rotation of the focus operating ring 112.

The zoom operating ring 116 having ring-shape rotatable around the optical axis OA, which is rotatable around the optical axis OA, is radially fitted into the exterior ring 113, and the position of the zoom operating ring 116 in the optical axis direction is regulated by the exterior ring 113 itself and the intermediate barrel 115, which is fixed to the exterior ring 113 with screws (not shown). The zoom operating ring 116 is provided with a groove (not shown) in which a movable element of a resistance type linear sensor (not shown) serving as a position detection unit is fitted, and an output of the resistance type linear sensor changes according to a rotation amount of the zoom operating ring 116, so that zoom position information can be detected. The resistance type linear sensor is an electrical component mounted on a flexible printed circuit board (hereinafter referred to as a zoom rotation detection flexible printed circuit board, not shown), and the zoom rotation detection flexible printed circuit board is fixed to the exterior ring 113. Further, the zoom rotation detection flexible printed circuit board is connected to a connector on the control board 104 but may be connected to the control board 104 via the signal transmission member 105 that transmits a control signal. Based on the output of the resistance type linear sensor according to the rotation of the zoom operating ring 116, the zoom unit is moved advances and retreats along the optical axis OA.

An AF/MF changeover switch (not shown) is fixed to the exterior ring 113 to switch a focus mode to an autofocus (hereinafter, AF) mode, which performs the focusing operation automatically, or a manual focus (hereinafter, MF) mode, which operates by manually rotating the focus operating ring 112. More specifically, the AF/MF changeover switch is mounted on and fixed to a flexible printed circuit board (hereinafter referred to as a switch flexible board, not shown). The switch flexible board is connected to a connector on the control board 104 but may be connected to the control board 104 via the signal transmission member 105 that transmits a control signal.

As described above, the first linear guide member 107, the second linear guide member 110, the fourth lens unit L4, the control board 104, the first lens holding frame 106, the communication member 102, the light amount regulating member, the exterior member 111, the driving unit 103, and the signal transmission member 105 are fixed to the coupling member 101. However, one of the above members or at least two of them may be (directly) fixed to the coupling member 101. According to the present disclosure, it is possible to provide the lens apparatus 100 in which reduction in size and weight is realized.

### Example 2

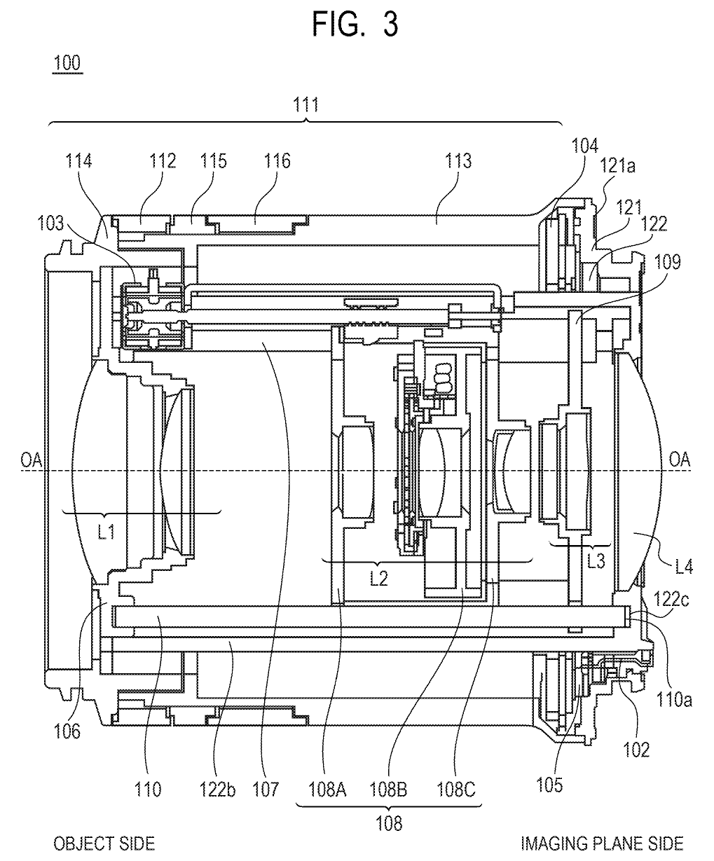

A lens apparatus 100 according to an example 2 of the present disclosure will be described with reference to FIG. 3. In FIG. 3, the same members as those in example 1 are denoted by the same reference numerals. FIG. 3 is a schematic cross-sectional view of the lens apparatus 100 according to example 2 in a state in which the exterior member 111 is incorporated. The lens apparatus 100 according to example 2 further includes a fixed barrel 122 (first fixed barrel, first fixed member).

The end portion 110a of the second linear guide member 110 on the imaging plane side is fitted to an attachment portion 122c formed in the fixed barrel 122. The attachment portion 122c is closer to the imaging surface than an abutting surface 121a orthogonal to the optical axis OA on which a coupling member 121 contacts the imaging apparatus 200. The end portion 110a is closer to the imaging surface than the abutting surface 121a provided on the coupling member 121 for coupling with the camera body 200a. Similarly, an end portion (not shown) of the first linear guide member 107 on the imaging plane side is fitted to the fixed barrel 122 and is located closer to the imaging plane side than the abutting surface 121a with the of the camera body 200a. The coupling member 121 is fixed to the fixed barrel 122.

The fixed barrel 122 includes an extending portion 122b extending in the optical axis direction and is connected to the first lens holding frame 106 on the object side of the extending portion 122b. At least one driving unit 103 for moving the second lens unit holding frame 108 and the third lens holding frame 109 forward and backward along the optical axis OA is fixed to the extending portion 122b extending toward the object side of the fixed barrel 122 fixed to the coupling member 121.

As in the example 1, the end portion 110a of the first linear guide member 107 or the first linear guide member 107 and the second linear guide member 110 on the imaging plane side is configured to be located closer to the imaging plane side than the abutting surface 121a of the coupling member 121 with the camera body 200a. As a result, the second lens unit holding frame 108 and the third lens holding frame 109 suspended from the first linear guide member 107 can have a fitting length in the optical axis direction with respect to the first linear guide member 107 as long as possible within a movable range in the optical axis direction. With this configuration, it is possible to suppress the collapse of the lens holding frame.

Further, a second fixed member (second fixed barrel) (not shown) may be provided on the object side. The extending portion 122b of the fixed barrel 122 may be fixed to the first lens holding frame 106 or the second fixing member on the object side of the extending portion 122b, and one of the first lens holding frame 106 and the second fixing member may have a second fixing portion for holding one end of the second linear guide member 110 on the object side.

The control board 104 is arranged inside the exterior member 111 (at a position close to the optical axis) and on the outer peripheral side of the fixed barrel 122 (at a position away from the optical axis). In addition, since it is possible to access each lens unit from the radial direction in a state where the exterior member 111 is not attached, optical adjustment in the entire optical system is also simple. Although preferred examples of the present disclosure have been described above, the present disclosure is not limited to these examples, and various modifications and changes can be made within the scope of the gist of the present disclosure.

### Application Example

FIG. 4 is a schematic diagram illustrating a configuration example of the imaging apparatus 200 using the lens apparatus 100 to which the present disclosure is applied. The imaging apparatus 200 includes the camera body 200a comprising an image-pickup element 200b for capturing an image of an object formed by the lens apparatus 100. The imaging system includes a lens apparatus 100 and the imaging apparatus 200.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-033423, filed Mar. 4, 2025, which is hereby incorporated by reference herein in its entirety.

What is claimed is:

1. A lens apparatus comprising:
a holding portion configured to hold a lens;
a connecting portion connected to the imaging apparatus; and
a guide portion configured to guide a movement of the holding portion in an optical axis direction,
wherein the connecting portion includes an abutting surface abutting on the imaging apparatus in the optical axis direction and a first fixing portion to which the guide portion is fixed, and
wherein the first fixing portion is arranged at a position closer to an imaging surface than the abutting surface.

2. The lens apparatus according to claim 1, further comprising a driving unit configured to move the holding portion in the optical axis direction, wherein the driving unit is fixed to the connecting portion.

3. The lens apparatus according to claim 2, wherein the connecting portion includes an extending portion extending in the optical axis direction, and the driving unit is fixed to the extending portion.

4. The lens apparatus according to claim 3, wherein the extending portion is fixed to the holding portion.

5. The lens apparatus according to claim 4, wherein the holding portion includes a second fixing portion configured to hold one end of the guide portion on an object side.

6. The lens apparatus according to claim 5, further comprising a control unit configured to control the driving unit, wherein the control unit is arranged at a position more distant from the optical axis than the extending portion.

7. The lens apparatus according to claim 1, further comprising a driving unit configured to move the holding portion in the optical axis direction, and a first fixed barrel fixed to the connecting portion,
wherein the first fixed barrel includes an extending portion extending in the optical axis direction, and the driving unit is fixed to the extending portion.

8. The lens apparatus according to claim 7, wherein the extending portion is fixed to a second fixed barrel.

9. The lens apparatus according to claim 8, wherein the second fixed barrel includes a second fixing portion configured to hold one end of the guide portion on an object side.

10. The lens apparatus according to claim 9, further comprising a control unit configured to control the driving unit, wherein the control unit is arranged at a position more distant from the optical axis than the extending portion.

11. The lens apparatus according to claim 1, further comprising an exterior portion arranged at a position farther from the optical axis than the holding portion, wherein the exterior portion is fixed to the connecting portion.

12. The lens apparatus according to claim 1, wherein the holding portion moves in the optical axis direction during focusing or zooming.

13. An imaging system comprising: the lens apparatus according to claim 1; and an imaging apparatus.
